(19) United States
(12) Patent Application Publication
(10) Pub. No.: US 2014/0368967 A1
(43) Pub. Date: Dec. 18, 2014

(54) MULTILAYER CERAMIC CAPACITOR AND BOARD HAVING THE SAME MOUNTED THEREON

(71) Applicant: SAMSUNG ELECTRO-MECHANICS CO., LTD., Suwon (KR)

(72) Inventors: Young Ghyu AHN, Suwon (KR); Heung Kil PARK, Suwon (KR); Soon Ju LEE, Suwon (KR); Byoung Hwa LEE, Suwon (KR); Sang Soo PARK, Suwon (KR)

(73) Assignee: SAMSUNG ELECTRO-MECHANICS CO., LTD., Suwon (KR)

(21) Appl. No.: 14/135,338

(22) Filed: Dec. 19, 2013

(30) Foreign Application Priority Data
Jun. 14, 2013 (KR) 10-2013-0068493

(51) Int. Cl. H01G 4/30; H01G 4/005

(52) U.S. Cl. CPC H01G 4/30; H01G 4/005
USPC 361/301.4

(57) ABSTRACT

There is provided a multilayer ceramic capacitor, including: a ceramic body; an active layer including a plurality of first and second internal electrodes; upper and lower cover layers; first and second external electrodes, wherein 0.75×W≦T≦1.25×W, 0.081≦b/(a×(W−b))≦2.267, and 0.267≦c/L≦0.940 are satisfied, where T denotes a thickness of the ceramic body, a denotes a thickness of the lower cover layer, b denotes a width of the first or second internal electrode, L denotes a length of the ceramic body, c denotes a distance between outer edges of the first and second external electrodes, and d denotes a distance between inner edges of the first and second external electrodes.

### CROSS-REFERENCE TO RELATED APPLICATION

This application claims the benefit of Korean Patent Application No. 10-2013-0068493 filed on Jun. 14, 2013, with the Korean Intellectual Property Office, the disclosure of which is incorporated herein by reference.

### BACKGROUND

The present disclosure relates to a multilayer ceramic capacitor and a board having the same mounted thereon.

A multilayer ceramic capacitor, one of multilayer chip electronic components, is a chip-type condenser that is mounted on printed circuit boards of various electronic products such as display devices including liquid crystal displays (LCDs) and plasma display panels (PDPs), computers, personal digital assistants (PDAs), cell phones, and the like, to allow electricity to be charged therein and discharged therefrom.

A multilayer ceramic capacitor (MLCC) is used in various types of electronic components since it is relatively small and can be easily mounted while implementing high capacitance.

The multilayer ceramic capacitor may have a structure in which dielectric layers and internal electrodes having opposite polarities are alternately stacked.

Since the dielectric layers have piezoelectric and electrostrictive properties, when direct current (DC) or alternating current (AC) voltage is applied to the multilayer ceramic capacitor, a piezoelectric effect may occur between the internal electrodes, causing vibrations.

The vibrations may be transferred to a printed circuit board on which the multilayer ceramic capacitor is mounted via external electrodes of the multilayer ceramic capacitor, so that the entirety of the printed circuit board serves as a sound reflecting surface to cause a vibration sound, which is noise.

The vibration sound may correspond to an audio frequency within a range of 20 Hz to 20,000 Hz, commonly known as acoustic noise, which may cause listener discomfort, and a large amount of research into methods of reducing acoustic noise is currently ongoing.

Patent Document 1 discloses a structure in which internal electrodes are exposed to both side surfaces of a ceramic body, but fails to disclose positional values of external electrodes formed on the ceramic body in a length direction thereof.

### RELATED ART DOCUMENT

(Patent Document 1) Korean Patent Laid-open Publication No. 2006-0068404

### SUMMARY

An aspect of the present disclosure may provide a multilayer ceramic capacitor capable of effectively reducing acoustic noise caused by vibrations resulting from a piezoelectric effect.

According to an aspect of the present disclosure, a multilayer ceramic capacitor may include: a ceramic body having a plurality of dielectric layers stacked therein; an active layer including a plurality of first and second internal electrodes alternately disposed with each of the dielectric layers interposed therebetween, each first internal electrode having a pair of first lead portions extending to be exposed to side surfaces of the ceramic body, and each second internal electrode having a pair of second lead portions extending to be exposed to the side surfaces of the ceramic body in positions spaced apart from the pair of first lead portions in a length direction of the ceramic body; upper and lower cover layers formed above and below the active layer, respectively; a first external electrode including a pair of first connecting portions disposed to oppose each other on the side surfaces of the ceramic body and be electrically connected to the pair of first lead portions and a first mounting portion disposed on a lower surface of the ceramic body and connecting lower ends of the pair of first connecting portions to each other; a second external electrode including a pair of second connecting portions disposed to oppose each other on the side surfaces of the ceramic body in positions spaced apart from the pair of first connecting portions in the length direction of the ceramic body and be electrically connected to the pair of second lead portions, and a second mounting portion disposed on the lower surface of the ceramic body and connecting lower ends of the pair of second connecting portions to each other, wherein 0.75×W≦T≦1.25×W, 0.081≦b/(a×(W−b))≦2.267, and 0.267≦c/L≦0.940 are satisfied, where T denotes a thickness of the ceramic body, a denotes a thickness of the lower cover layer, b denotes a width of the first or second internal electrode, L denotes a length of the ceramic body, c denotes a distance between outer edges of the first and second external electrodes, and d denotes a distance between inner edges of the first and second external electrodes.

The first external electrode may further include a third mounting portion disposed on an upper surface of the ceramic body and connecting upper ends of the pair of first connecting portions to each other, and the second external electrode may further include a fourth mounting portion disposed on the upper surface of the ceramic body and connecting upper ends of the pair of second connecting portions to each other.

According to another aspect of the present disclosure, a multilayer ceramic capacitor may include: a ceramic body having a plurality of dielectric layers stacked therein; an active layer including pairs of first internal electrodes and pairs of second internal electrodes alternately disposed with each of the dielectric layers interposed therebetween, each pair of first internal electrodes having respective first lead portions extending to be alternately exposed to side surfaces of the ceramic body, and each pair of second internal electrodes having respective second lead portions extending to be alternately exposed to the side surfaces of the ceramic body in positions spaced apart from the first lead portions in a length direction of the ceramic body; upper and lower cover layers formed above and below the active layer, respectively;

a first external electrode including a pair of first connecting portions disposed to oppose each other on the side surfaces of the ceramic body and be electrically connected to the first lead portions, and a pair of first mounting portions extending from lower ends of the pair of first connecting portions to portions of a lower surface of the ceramic body; a second external electrode including a pair of second connecting portions disposed to oppose each other on the side surfaces of the ceramic body in positions spaced apart from the pair of first connecting portions in the length direction of the ceramic body and be electrically connected to the second lead portions, and a pair of second mounting portions extending from lower ends of the pair of second connecting portions to portions of the lower surface of the ceramic body, wherein 0.75×W≦T≦1.25×W, 0.081≦b/(a×(W−b))≦2.267, and 0.267≦c/L≦0.940 are satisfied, where T denotes a thickness of the ceramic body, a denotes a thickness of the lower cover layer, b denotes a width of the first or second internal electrode, L denotes a length of the ceramic body, c denotes a distance between outer edges of the first and second external electrodes, and d denotes a distance between inner edges of the first and second external electrodes.

The first external electrode may further include a third mounting portion extending from upper ends of the pair of first connecting portions to portions of an upper surface of the ceramic body, and the second external electrode may further include a fourth mounting portion extending from upper ends of the pair of second connecting portions to portions of the upper surface of the ceramic body.

6.2 μm≦a≦149.5 μm may be satisfied.

0.373≦(W−b)/a≦12.435 may be satisfied.

The lower cover layer may be thicker than the upper cover layer.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a perspective view schematically illustrating a multilayer ceramic capacitor according to an exemplary embodiment of the present disclosure;

FIG. 2 is a cross-sectional view taken along line A-A′ of FIG. 1;

FIG. 3 is an exploded perspective view illustrating the structure of first and second internal electrodes in a multilayer ceramic capacitor according to an exemplary embodiment of the present disclosure;

FIG. 4 is a cross-sectional view of a multilayer ceramic capacitor according to an exemplary embodiment of the present disclosure, taken in a width direction;

FIG. 5 is a cross-sectional view of the multilayer ceramic capacitor of FIG. 1 mounted on a printed circuit board, taken in a length direction;

FIG. 6 is a perspective view schematically illustrating a multilayer ceramic capacitor according to another exemplary embodiment of the present disclosure; and

FIG. 7 is an exploded perspective view illustrating the structure of first and second internal electrodes in a multilayer ceramic capacitor according to another exemplary embodiment of the present disclosure.

### DETAILED DESCRIPTION

Exemplary embodiments of the present disclosure will now be described in detail with reference to the accompanying drawings.

The disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

In the drawings, the shapes and dimensions of elements maybe exaggerated for clarity, and the same reference numerals will be used throughout to designate the same or like elements.

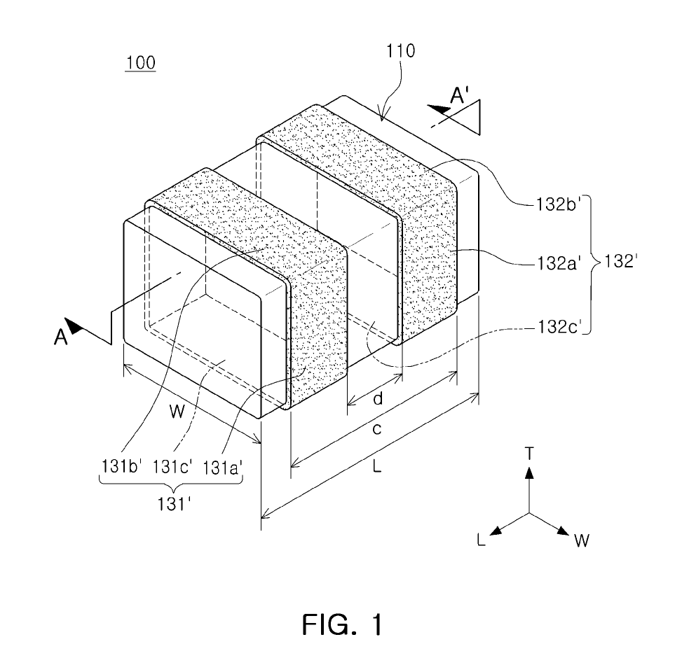

In order to clearly describe exemplary embodiments, L, W and T shown in FIG. 1 indicate directions of a ceramic body, i.e., a length direction, a width direction, and a thickness direction, respectively. Here, the thickness direction may be the same as a direction in which dielectric layers are stacked.

In addition, according to exemplary embodiments, for the convenience of description, two surfaces of the ceramic body in a width direction, on which first and second external electrodes are formed, are referred to as side surfaces, two surfaces thereof perpendicular to the side surfaces are referred to as end surfaces, and two surfaces thereof in a thickness direction are referred to as upper and lower surfaces.

### Multilayer Ceramic Capacitor

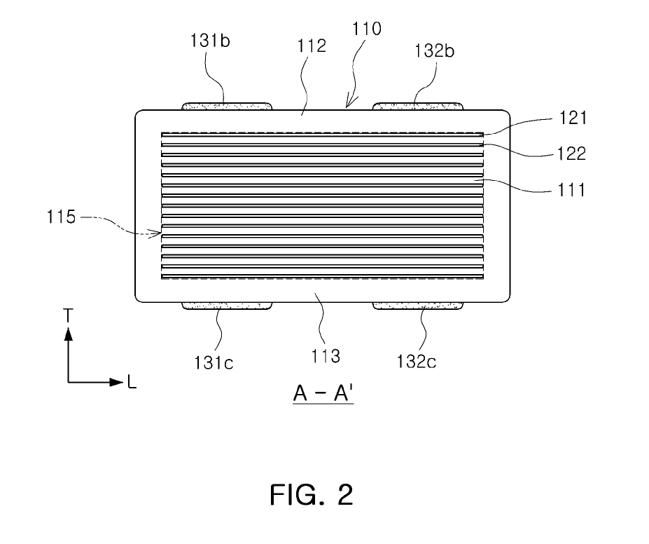

FIG. 1 is a perspective view schematically illustrating a multilayer ceramic capacitor according to an exemplary embodiment of the present disclosure; and FIG. 2 is a cross-sectional view taken along line A-A′ of FIG. 1.

Referring to FIGS. 1 and 2, a multilayer ceramic capacitor 100 according to an exemplary embodiment of the present disclosure may include a ceramic body 110, an active layer 115 including a plurality of first and second internal electrodes 121 and 122, upper and lower cover layers 112 and 113, and first and second external electrodes 131 and 132.

The ceramic body 110 may be formed by stacking a plurality of dielectric layers 111 and then sintering the same.

The shape and dimensions of the ceramic body 110 and the number of stacked dielectric layers 111 are not limited to those illustrated in the embodiment.

Further, the plurality of dielectric layers 111 forming the ceramic body 110 may be in a sintered state, so that boundaries between adjacent dielectric layers 111 are not readily apparent without a scanning electron microscope (SEM).

The ceramic body 110 may include the active layer 115 contributing to creating capacitance of the capacitor, and the upper and lower cover layers 112 and 113 formed above and below the active layer 115, respectively, as upper and lower margin portions.

The active layer 115 may be formed by alternately stacking the first and second internal electrodes 131 and 132 with one dielectric layers 111 interposed therebetween.

The thickness of the dielectric layers 111 may be arbitrarily altered depending on a capacitance design of the multilayer ceramic capacitor 100, and the thickness of a single dielectric layer may be, but is not limited to, 0.01 μm to 1.00 μm after sintering.

Further, the dielectric layers 111 may include a ceramic powder having high permittivity, e.g., a BaTiO3-based powder or a SrTiO3-based powder, but are not limited thereto.

The upper and lower cover layers 112 and 113 may be formed of the same material and may have the same configuration as those of the dielectric layers 111, except that they do not include any internal electrode.

The upper and lower cover layers 112 and 113 may be formed by using a single dielectric layer or stacking two or more dielectric layers on the upper and lower surfaces of the active layer 115, respectively. Basically, the upper and lower cover layers 112 and 113 may serve to prevent damage to the first and second internal electrodes 121 and 122 caused by physical or chemical stress.

Here, the lower cover layer 113, if necessary, may be thicker than the upper cover layer 112 by increasing the number of stacked dielectric layers.

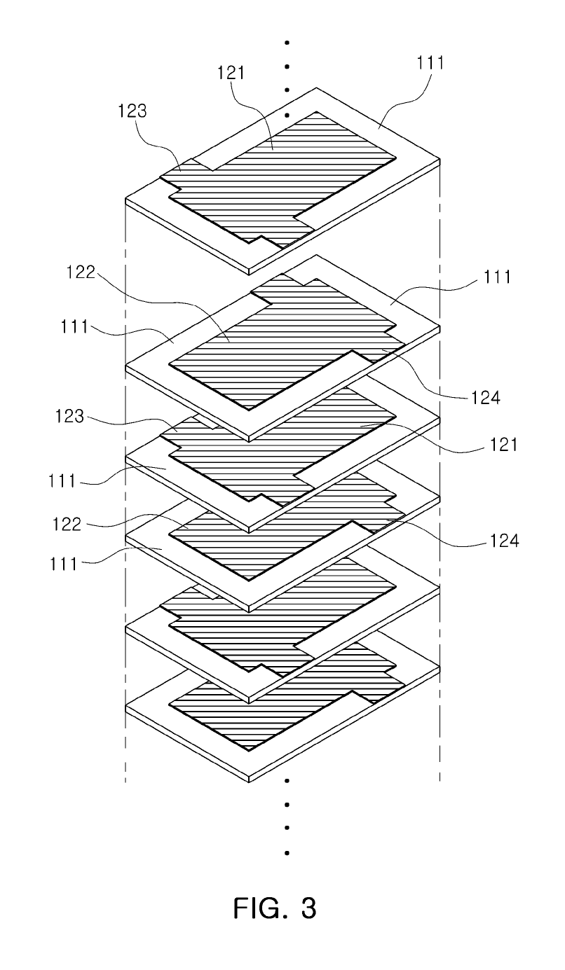

FIG. 3 is an exploded perspective view illustrating the structure of first and second internal electrodes of a multilayer ceramic capacitor according to an exemplary embodiment of the present disclosure.

Referring to FIG. 3, the first and second internal electrodes 121 and 122 having opposite polarities may be formed by printing a conductive paste including a conductive metal on the dielectric layers 111 at a predetermined thickness. The first and second internal electrodes 121 and 122 may be alternately exposed to both side surfaces of the ceramic body, having one dielectric layer 111 interposed between the internal electrodes, and they may be electrically insulated from each other due to the interposed dielectric layer.

The first internal electrode 121 may have a pair of first lead portions 123 extending to be simultaneously exposed to the side surfaces of the ceramic body 110, and the second internal electrode 122 may have a pair of second lead portions 124 extending to be simultaneously exposed to the side surfaces of the ceramic body 110 in positions spaced apart from the first lead portions 123 in the length direction of the ceramic body 110.

The first and second internal electrodes 121 and 122 may be electrically connected to the first and second external electrodes 131 and 132, respectively, through portions of the first and second lead portions 123 and 124 alternately exposed to the side surfaces of the ceramic body 110.

Accordingly, when voltage is applied to the first and second external electrodes 131 and 132, charges are accumulated between the first and second internal electrodes 121 and 122 facing each other, and the capacitance of the multilayer ceramic capacitor 100 is proportional to an area of an overlapping region between the first and second internal electrodes 121 and 122 in the active layer 115.

The thickness of the first and second internal electrodes 121 and 122 may be determined depending on intended use of capacitors, and may be, but is not limited to, 0.2 μm to 1.0 μm, taking into account the size of the ceramic body 110.

The conductive metal contained in the conductive paste forming the first and second internal electrodes 121 and 122 may be, but is not limited to, nickel (Ni), copper (Cu), palladium (Pd) or an alloy thereof.

The method of printing of the conductive paste may include, but is not limited to, screen printing or gravure printing.

The first and second external electrodes 131 and 132 may be formed of a conductive paste containing a conductive metal, and the conductive metal may be nickel (Ni), copper (Cu), palladium (Pd), gold (Au) or an alloy thereof, but is not limited thereto.

The first external electrode 131 may include a pair of first connecting portions 131a and a first mounting portion 131c formed on the lower surface of the ceramic body 110 and the second external electrode 132 may include a pair of second connecting portions 132a and a second mounting portion 132c formed on the lower surface of the ceramic body 110, the first and second mounting portions being provided to mount the multilayer ceramic capacitor on a board.

The pair of first connecting portions 131a may be disposed to oppose each other on both side surfaces of the ceramic body 110 and be electrically connected to the exposed portions of the first lead portions 123 stacked in the thickness direction of the ceramic body.

The first mounting portion 131c may be formed on the lower surface of the ceramic body 110 and ends thereof may be connected to lower ends of the pair of first connecting portions 131a.

The pair of second connecting portions 132a may be disposed to oppose each other on both side surfaces of the ceramic body 110 while being spaced apart from the first connecting portions 131a in the length direction of the ceramic body, and be electrically connected to the exposed portions of the second lead portions 124 stacked in the thickness direction of the ceramic body.

The second mounting portion 132c may be formed on the lower surface of the ceramic body 110 and ends thereof may be connected to lower ends of the pair of second connecting portions 132a.

The first and second external electrodes 131 and 132 may be disposed inwardly from the end surfaces of the ceramic body 110 in the length direction thereof, the displacement of the external electrodes is decreased, and thus points at which force is applied at the time of mounting the capacitor on a printed circuit board become closer to one another, thereby suppressing displacement of the board. Thus, the transfer of vibrations occurring in the multilayer ceramic capacitor 100 to the printed circuit board may be reduced to thereby decrease acoustic noise.

The first external electrode 131 may further include a third mounting portion 131b formed on the upper surface of the ceramic body 110 and connecting upper ends of the pair of first connecting portions 131a, and the second external electrode 132 may further include a fourth mounting portion 132b formed on the upper surface of the ceramic body 110 and connecting upper ends of the pair of second connecting portions 132a. The third and fourth mounting portions 131b and 132b may oppose the first and second mounting portions 131c and 132c formed on the lower surface of the ceramic body 110.

Now, a relationship between the dimensions of elements included in a multilayer ceramic capacitor and acoustic noise according to an exemplary embodiment of the present disclosure will be described.

A thickness of the ceramic body 110 is referred to as T, a thickness of the lower cover layer 113 is referred to as a, a width of the first or second internal electrode 121 or 122 is referred to as b, a length of the ceramic body 110 is referred to as L, a distance between outer edges of the first and second external electrodes 131 and 132 is referred to as c, and a distance between inner edges of the first and second external electrodes 131 and 132 is referred to as d.

When voltages having opposite polarities are applied to the first and second external electrodes 131 and 132 of the multilayer ceramic capacitor 100, the ceramic body 110 is in-phase shifted due to an inverse piezoelectric effect of the dielectric layers 111. Under particular conditions, however, an anti-phase shift may arise, and the magnitude of acoustic noise may be greatly influenced by such an anti-phase shift.

Such an anti-phase shift is influenced by the thickness of the cover layer of the ceramic body 110, more specifically the thickness a of the lower cover layer 113 on the mounting surface, the width W of the ceramic body 110, a length (W−b) of margins on the left and right sides, and the like. Generally, the anti-phase shift becomes larger, as the thickness a is increased, the width W is decreased, and the length W−b is increased.

In this exemplary embodiment, in order to further reduce the acoustic noise, 0.75×W≦T≦1.25×W, 0.08≦b/(a×(W−b))≦2.267 and 0.267≦c/L≦0.940 may be satisfied.

Further, the thickness a may satisfy 6.2 μm≦a≦149.5 μm.

Further, (W−b)/a may satisfy 0.373≦(W−b)/a≦12.435.

### EXPERIMENTAL EXAMPLE

Multilayer ceramic capacitors according to Inventive

Examples and Comparative Examples were manufactured as described below.

A slurry containing a powder such as a barium titanate (BaTiO₃) powder was applied to carrier films and dried to prepare a plurality of ceramic green sheets having a thickness of 1.8 μm.

Then, a conductive paste for nickel internal electrodes is applied to the ceramic green sheets using a screen, to form the first and second internal electrodes 121 and 122 having the first and second lead portions 123 and 124 alternately exposed to both sides of the ceramic green sheets.

Here, approximately three hundred seventy (370) ceramic green sheets were stacked to produce a laminate, and the laminate was isostatically pressed under a pressure of approximately 1000 kgf/cm² at a temperature of approximately 85° C.

Then, the pressed laminate was cut into individual chips, and the cut chips was subjected to de-binding in air atmosphere at approximately 230° C. for approximately sixty hours.

Then, the chips were sintered at approximately 1,200° C. in a reducing atmosphere with oxygen partial pressure between 10⁻¹¹ atm and 10⁻¹⁰ atm, lower than an Ni/NiO equilibrium oxygen partial pressure, in order for the first and second internal electrodes 121 and 122 not to be oxidized, thereby forming the ceramic bodies 110.

The length×width (L×W) of the ceramic body 110 after sintering was approximately 1.64 mm×0.88 mm (L×W, 1608 size). Then, the first and second external electrodes 131 and 132 were formed on side surfaces of the individual ceramic bodies 110, whereby the multilayer ceramic capacitors 100 were fabricated.

Here, the fabrication tolerance was ±0.1 mm or less in length×width (L×W), and in the case that the fabricated capacitors satisfied the tolerance, acoustic noise thereof was measured.

TABLE 1

| | a | | W | W − b | | | Humidity resistance | |
|---|---|---|---|---|---|---|---|---|
| No | (um) | B (um) | (um) | (um) | b/(a * (W − b)) | (W − b)/a | NG rate | A/N (dBA) |
| 1 | 8.2 | 812.2 | 868.8 | 56.6 | 4.484 | 27.688 | 3/400 | 22.4 |
| 2 | 6.8 | 812.5 | 869.4 | 56.9 | 2.267 | 9.082 | 0/400 | 22.1 |
| 3 | 9.8 | 809.2 | 867.5 | 58.3 | 1.416 | 5.949 | 0/400 | 22.0 |
| 4 | 15.0 | 807.4 | 866.2 | 58.8 | 0.915 | 3.920 | 0/400 | 22.4 |
| 5 | 48.4 | 810.8 | 866.1 | 55.3 | 0.303 | 1.143 | 0/400 | 23.6 |
| 6 | 100.4 | 809.0 | 864.0 | 55.0 | 0.147 | 0.548 | 0/400 | 28.6 |
| 7 | 148.7 | 815.3 | 870.8 | 55.5 | 0.099 | 0.378 | 0/400 | 24.9 |
| 8 | 195.0 | 812.4 | 869.9 | 57.5 | 0.072 | 0.295 | 0/400 | 31.4 |
| 9 | 247.6 | 813.6 | 868.4 | 54.8 | 0.060 | 0.221 | 0/400 | 34.2 |
| 10 | 32 | 847.4 | 915.5 | 68.1 | 8.389 | 21.281 | 2/400 | 22.7 |
| 11 | 6.4 | 851.2 | 919.6 | 68.4 | 1.944 | 10.688 | 0/400 | 22.6 |
| 12 | 9.7 | 856.6 | 922.2 | 65.6 | 1.346 | 6.763 | 0/400 | 21.5 |
| 13 | 15.0 | 841.8 | 910.6 | 68.6 | 0.816 | 4.587 | 0/400 | 21.8 |
| 14 | 48.4 | 848.8 | 917.7 | 68.9 | 0.255 | 1.424 | 0/400 | 22.8 |
| 15 | 97.2 | 851.1 | 918.5 | 67.4 | 0.180 | 0.698 | 0/400 | 24.1 |
| 16 | 149.5 | 854.9 | 921.4 | 68.5 | 0.086 | 0.445 | 0/400 | 24.6 |
| 17 | 195.0 | 844.7 | 911.4 | 66.7 | 0.065 | 0.842 | 0/400 | 30.8 |
| 18 | 247.6 | 848.6 | 916.7 | 68.1 | 0.050 | 0.276 | 0/400 | 33.6 |
| 19 | 30 | 886.6 | 965.8 | 79.2 | 3.731 | 26.400 | 2/400 | 23.1 |
| 20 | 6.2 | 887.5 | 965.4 | 77.1 | 1.857 | 12.435 | 0/400 | 22.5 |
| 21 | 9.7 | 885.2 | 961.5 | 76.3 | 1.196 | 7.886 | 0/400 | 21.0 |
| 22 | 14.8 | 882.3 | 958.2 | 75.9 | 0.785 | 5.126 | 0/400 | 21.1 |
| 23 | 45.2 | 886.8 | 962.1 | 75.8 | 0.244 | 1.562 | 0/400 | 22.4 |
| 24 | 96.8 | 888.1 | 966.0 | 77.9 | 0.118 | 0.605 | 0/400 | 23.8 |
| 25 | 146.9 | 894.0 | 969.5 | 75.3 | 0.081 | 0.513 | 0/400 | 24.2 |
| 26 | 194.1 | 880.7 | 956.6 | 75.9 | 0.060 | 0.391 | 0/400 | 32.4 |
| 27 | 246.7 | 884.5 | 961.9 | 77.0 | 0.047 | 0.312 | 0/400 | 34.7 |

Here, A/N denotes acoustic noise.

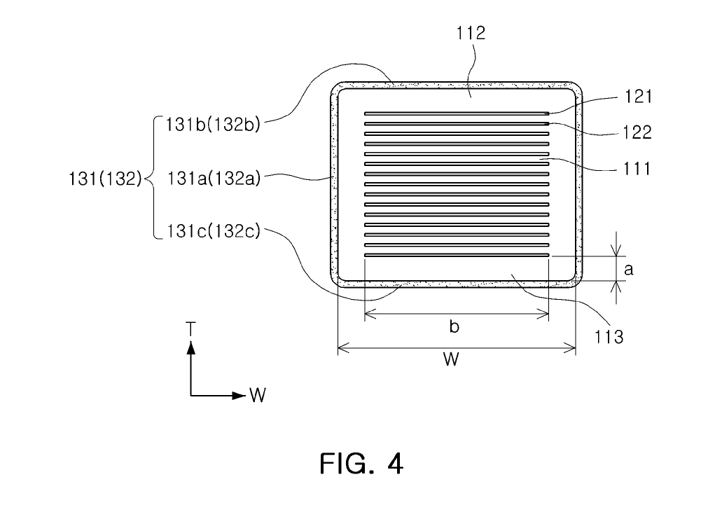

The data in Table 1 was obtained by measuring the dimensions of each capacitor from an image, captured by a scanning electron microscope (SEM), of a cross-section of each capacitor cut in a width-thickness direction at the center of the ceramic body 110 in a length direction thereof, as shown in FIG. 4.

Here, the thickness of the ceramic body 110 is referred to as T, the thickness of the lower cover layer 113 is referred to as a, the width of the first or second internal electrode 121 or 122 is referred to as b, the length of the ceramic body 110 is referred to as L, the distance between the outer edges of the first and second external electrodes 131 and 132 is referred to as c, and the distance between the inner edges of the first and second external electrodes 131 and 132 is referred to as d.

In order to measure acoustic noise, one sample (a multilayer ceramic capacitor) for each acoustic noise measuring board was mounted on a printed circuit board while upper and lower portions of the sample were distinguished, and then the board was placed on a measuring jig.

Then, DC voltages and voltage variations were applied to both terminals of the sample placed on the measuring jig by a DC power supply and a function generator. Acoustic noise was measured through a microphone installed immediately above the printed circuit board.

As can be seen from Table 1, in samples 2 to 7, 11 to 16 and 20 to 25 satisfying 0.75×W≦T≦1.25×W, 0.081≦b/(a×(W−b))≦2.267, 6.2 μm≦a≦149.5 μm, and 0.373≦(W−b)/a≦12.435, there was no humidity resistance failure while acoustic noise was below 25 dBA.

TABLE 2

| No | c | d | L | c/L | mounting failure rate | A/N |
|---|---|---|---|---|---|---|
| 1 | 1669.7 | 1372.2 | 1669.3 | 1.000 | 0/100 | 34.2 |
| 2 | 1570.4 | 1273.3 | 1670.2 | 0.940 | 0/100 | 26.7 |
| 3 | 1468.5 | 1171.2 | 1668.1 | 0.880 | 0/100 | 24.7 |
| 4 | 1367.7 | 1070.3 | 1666.9 | 0.820 | 0/100 | 24.2 |
| 5 | 1167.0 | 869.1 | 1666.3 | 0.700 | 0/100 | 23.6 |
| 6 | 961.7 | 664.5 | 1661.6 | 0.579 | 0/100 | 23.0 |
| 7 | 771.5 | 473.7 | 1617.3 | 0.462 | 0/100 | 21.2 |
| 8 | 591.3 | 294.2 | 1670.4 | 0.354 | 0/100 | 20.8 |
| 9 | 519.9 | 222.4 | 1669.2 | 0.311 | 0/100 | 20.7 |
| 10 | 446.5 | 149.1 | 1670.2 | 0.267 | 0/100 | 20.1 |
| 11 | 347.2 | 49.9 | 1671.2 | 0.208 | 22/100 | 19.8 |

As the points at which force was exerted on the first and second external electrodes became closer, the transfer of vibrations occurring in the multilayer ceramic capacitor to the printed circuit board was significantly reduced. If the distance between the first and second external electrodes is too short, however, solders applied to the first and second external electrodes may contact one another due to mounting failures, causing short-circuits or the like.

As can be seen from Table 2, in samples 2 to 10 satisfying 0.267≦c/L≦0.940, there was no mounting failure while acoustic noise was below 25 dBA.

In sample 1, in which c/L exceeded 0.940, acoustic noise was barely reduced. In sample 11, in which c/L was below 0.267, acoustic noise was minimal but a mounting failure occurred.

Board having Multilayer Ceramic Capacitor Mounted Thereon

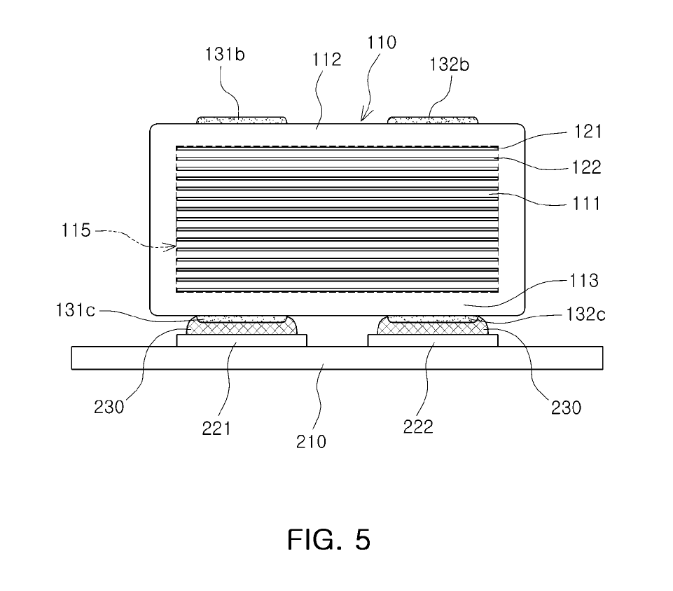

Referring to FIG. 5, a board having the multilayer ceramic capacitor 100 mounted thereon according to an exemplary embodiment may include a printed circuit board 210 on which the multilayer ceramic capacitor 100 is horizontally mounted, and first and second electrode pads 221 and 222 formed on an upper surface of the printed circuit board 210 and spaced apart from each other.

Here, the multilayer ceramic capacitor 100 may be mounted on the printed circuit board 210 while allowing the lower cover layer 113 to be disposed downwards, and may be electrically connected to the printed circuit board 210 by solders 230 in a state in which the first and second external electrodes 131 and 132 are in contact with the first and second electrode pads 221 and 222, respectively.

When voltage is applied to the multilayer ceramic capacitor 100 mounted on the printed circuit board 210, acoustic noise may arise.

The amount of the solders 230 connecting the first and second external electrodes 131 and 132 of the multilayer ceramic capacitor 100 to the first and second electrode pads 221 and 222 may be determined based on the size of the first and second electrode pads 221 and 222. Depending on the amount of the solders 230, the magnitude of acoustic noise may be adjusted.

### MODIFIED EXAMPLE

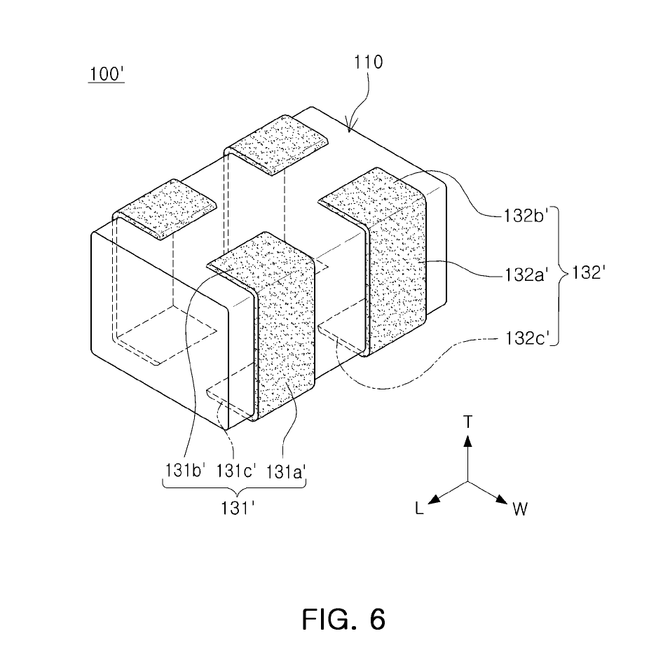

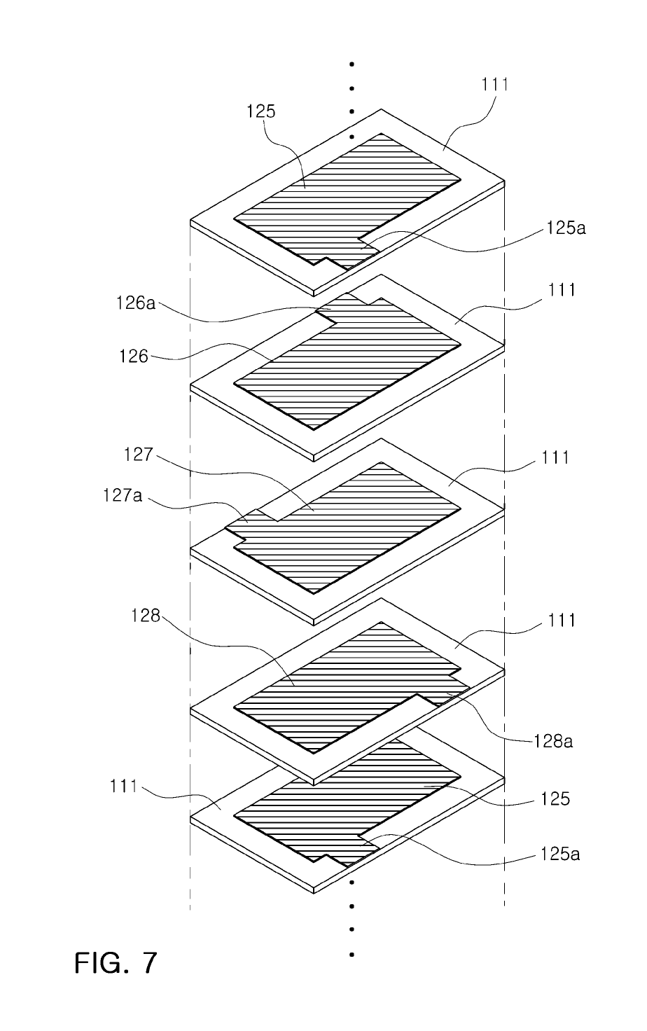

FIG. 6 is a perspective view schematically illustrating a multilayer ceramic capacitor according to another exemplary embodiment of the present disclosure, and FIG. 7 is an exploded perspective view illustrating the structure of first and second internal electrodes of a multilayer ceramic capacitor according to another exemplary embodiment of the present disclosure.

Hereafter, details related to a difference between thicknesses of lower and upper cover layers will be omitted in order to avoid a redundant description, and the structures of external electrodes and internal electrodes, different from those illustrated in the above-described embodiment, will be described in detail.

Referring to FIGS. 6 and 7, a multilayer ceramic capacitor 100′ according another exemplary embodiment of the present disclosure may have an active layer including pairs of first internal electrodes 125 and 127 having first lead portions 125a and 127a extending to be alternately exposed to side surfaces of the ceramic body 110, and pairs of second internal electrodes 126 and 128 having second lead portions 126a and 128a extending to be alternately exposed to the side surfaces of the ceramic body 110 in positions spaced apart from the first lead portions 125a and 127a in the length direction of the ceramic body, the first and second internal electrodes having one of dielectric layers 111 interposed therebetween. In addition, a first external electrode 131′ may include a pair of first connecting portions 131a′ disposed to oppose each other on the side surfaces of the ceramic body 110 and be electrically connected to the exposed portions of the first lead portions 125a and 127a stacked in the thickness direction of the ceramic body, and a pair of first mounting portions 131c′ extending from lower ends of the pair of first connecting portions 131a′ to portions of the lower surface of the ceramic body 110.

In addition, a second external electrode 132′ may include a pair of second connecting portions 132a′ disposed to oppose each other on the side surfaces of the ceramic body 110 in positions spaced apart from the pair of first connecting portions 131a′ in the length direction of the ceramic body 110 and electrically connected to the exposed portions of the second lead portions 126a and 128a, and a pair of second mounting portions 132c′ extending from lower ends of the pair of second connecting portions 132a′ to portions of the lower surface of the ceramic body 110.

The first external electrode 131′ may include a third mounting portion 131b′ extending from upper ends of the pair of first connecting portions 131a′ to portions of the upper surface of the ceramic body 110. The second external electrode 132′ may include a fourth mounting portion 132b′ extending from upper ends of the pair of second connecting portions 132a′ to portions of the upper surface of the ceramic body 110. The third and fourth mounting portions 131b′ and 132b′ may oppose the first and second mounting portions 131c′ and 132c′.

As set forth above, according to exemplary embodiments of the present disclosure, external electrodes may be disposed inwardly from end surfaces of a ceramic body in a length direction thereof so that displacement of the external electrodes is decreased and points at which force is applied become closer, thereby suppressing displacement of a board. Thus, the transfer of vibrations occurring in a multilayer ceramic capacitor to the board may be reduced to thereby decrease acoustic noise.

While exemplary embodiments have been shown and described above, it will be apparent to those skilled in the art that modifications and variations could be made without departing from the spirit and scope of the present disclosure as defined by the appended claims.

What is claimed is:

1. A multilayer ceramic capacitor, comprising:
a ceramic body having a plurality of dielectric layers stacked therein;
an active layer including a plurality of first and second internal electrodes alternately disposed with each of the dielectric layers interposed therebetween, each first internal electrode having a pair of first lead portions extending to be exposed to side surfaces of the ceramic body, and each second internal electrode having a pair of second lead portions extending to be exposed to the side surfaces of the ceramic body in positions spaced apart from the pair of first lead portions in a length direction of the ceramic body;
upper and lower cover layers formed above and below the active layer, respectively;
a first external electrode including a pair of first connecting portions disposed to oppose each other on the side surfaces of the ceramic body and be electrically connected to the pair of first lead portions and a first mounting portion disposed on a lower surface of the ceramic body and connecting lower ends of the pair of first connecting portions to each other;
a second external electrode including a pair of second connecting portions disposed to oppose each other on the side surfaces of the ceramic body in positions spaced apart from the pair of first connecting portions in the length direction of the ceramic body and be electrically connected to the pair of second lead portions, and a second mounting portion disposed on the lower surface of the ceramic body and connecting lower ends of the pair of second connecting portions to each other,
wherein 0.75×W≦T≦1.25×W, 0.081≦b/(a×(W−b))≦2.267, and 0.267≦c/L≦0.940 are satisfied, where T denotes a thickness of the ceramic body, a denotes a thickness of the lower cover layer, b denotes a width of the first or second internal electrode, L denotes a length of the ceramic body, c denotes a distance between outer edges of the first and second external electrodes, and d denotes a distance between inner edges of the first and second external electrodes.

2. The multilayer ceramic capacitor of claim 1, wherein 6.2 μm≦a≦149.5 μm is satisfied.

3. The multilayer ceramic capacitor of claim 1, wherein 0.373≦(W−b)/a≦12.435 is satisfied.

4. The multilayer ceramic capacitor of claim 1, wherein the first external electrode further includes a third mounting portion disposed on an upper surface of the ceramic body and connecting upper ends of the pair of first connecting portions to each other, and
the second external electrode further includes a fourth mounting portion disposed on the upper surface of the ceramic body and connecting upper ends of the pair of second connecting portions to each other.

5. The multilayer ceramic capacitor of claim 1, wherein the lower cover layer is thicker than the upper cover layer.

6. A board having a multilayer ceramic capacitor mounted thereon, the board comprising:
a printed circuit board having first and second electrode pads on an upper surface thereof; and
the multilayer ceramic capacitor of any one of claims 1 to 5 mounted on the first and second electrode pads.

7. A multilayer ceramic capacitor, comprising:
a ceramic body having a plurality of dielectric layers stacked therein;
an active layer including pairs of first internal electrodes and pairs of second internal electrodes alternately disposed with each of the dielectric layers interposed therebetween, each pair of first internal electrodes having respective first lead portions extending to be alternately exposed to side surfaces of the ceramic body, and each pair of second internal electrodes having respective second lead portions extending to be alternately exposed to the side surfaces of the ceramic body in positions spaced apart from the first lead portions in a length direction of the ceramic body;
upper and lower cover layers formed above and below the active layer, respectively;
a first external electrode including a pair of first connecting portions disposed to oppose each other on the side surfaces of the ceramic body and be electrically connected to the first lead portions, and a pair of first mounting portions extending from lower ends of the pair of first connecting portions to portions of a lower surface of the ceramic body;
a second external electrode including a pair of second connecting portions disposed to oppose each other on the side surfaces of the ceramic body in positions spaced apart from the pair of first connecting portions in the length direction of the ceramic body and be electrically connected to the second lead portions, and a pair of second mounting portions extending from lower ends of the pair of second connecting portions to portions of the lower surface of the ceramic body,
wherein 0.75×W≦T≦1.25×W, 0.081≦b/(a×(W−b))≦2.267, and 0.267≦c/L≦0.940 are satisfied, where T denotes a thickness of the ceramic body, a denotes a thickness of the lower cover layer, b denotes a width of the first or second internal electrode, L denotes a length of the ceramic body, c denotes a distance between outer edges of the first and second external electrodes, and d denotes a distance between inner edges of the first and second external electrodes.

8. The multilayer ceramic capacitor of claim 7, wherein 6.2 μm≦a≦149.5 μm is satisfied.

9. The multilayer ceramic capacitor of claim 7, wherein 0.373≦(W−b)/a≦12.435 is satisfied.

10. The multilayer ceramic capacitor of claim 7, wherein the first external electrode further includes a third mounting portion extending from upper ends of the pair of first connecting portions to portions of an upper surface of the ceramic body, and
the second external electrode further includes a fourth mounting portion extending from upper ends of the pair of second connecting portions to portions of the upper surface of the ceramic body.

11. The multilayer ceramic capacitor of claim 7, wherein the lower cover layer is thicker than the upper cover layer.

12. A board having a multilayer ceramic capacitor mounted thereon, the board comprising:
a printed circuit board having first and second electrode pads on an upper surface thereof; and
the multilayer ceramic capacitor of any one of claims 7 and 11 mounted on the first and second electrode pads.
